(19) United States
(12) Patent Application Publication
(10) Pub. No.: US 2015/0117994 A1
(43) Pub. Date: Apr. 30, 2015

(54) Front-end Carrier for a Prime Mover

(71) Applicant: Hubert Defrancq, Guignicourt (FR)

(72) Inventor: Hubert Defrancq, Guignicourt (FR)

(21) Appl. No.: 14/066,177

(22) Filed: Oct. 29, 2013

(51) Int. Cl. B60R 9/06; E05D 3/02; E06B 5/00; E05C 19/00; E06B 3/70; E06B 3/50

(52) U.S. Cl. CPC B60R 9/06; E06B 3/70; E06B 3/509; E06B 5/00; E05C 19/00; E05D 3/02; E06B 2003/7011
USPC 414/462; 49/394; 49/465

(57) ABSTRACT

A utility carrier that attaches to a hydraulically actuated hitch interface for a tractor, skid steer vehicle, or similar vehicle. The utility carrier has an L-shaped frame including a back panel and a floor. Couplers for releasable mounting of the carrier to a variety of hitch interfaces are mounted on the back panel. Corner posts, releasable to facilitate compact shipping, are used to releasably secure a front panel and two side panels to form, if desired, a closed area. The utility carrier can he lifted and tilted by the hydraulically actuated hitch interface.

### BACKGROUND OF THE INVENTION

The invention relates generally to a front-end carrier for a prime mover and, more specifically, to a carrier for attachment to the front end of a tractor, skid steer loader, or the like that can be used to transport a wide variety of equipment and materials and may be raised to selected heights by the hydraulic system of the prime mover.

There currently exist a wide variety of carriers or loaders that are attached to the front end of a tractor, skid steer loader or the like. One common such device is a loader bucket that is used to load materials, such as grain, dirt, gravel and the like. Loader buckets are typically of sturdy, steel construction to provide sufficient strength so that the bucket can be used to dig into the ground, support a full load of dense material such as gravel, withstand scooping of the material from a pile, and be durable. Loader buckets have a limited volume so that a full load of dense material can still be lifted by the hydraulic system of the tractor. The bucket can be tilted below horizontal to provide an angle of attack for digging, above horizontal to prevent spillage of material in the bucket, and below horizontal to dump the contents of the bucket. In addition, the sides of the bucket loader are commonly closed, at least partially, so that material is retained in the bucket. However, the closed sides make it difficult or impossible to pick up and carry any object that would have a dimension larger than the loader bucket.

Other front-end loading devices include a fork lift which engages primarily objects or material that are supported on a pallet. Typically, a pair of forwardly projected forks are used to engage the pallet whereupon the pallet and contents are lifted by the hydraulic system of the tractor. The range of motion of the fork lift is limited generally to a vertical plane and the geometry of the fork lift forks limits its use in supporting and lifting anything that is not of a suitable dimension and sufficiently rigid.

United States Patent Appl. Publ. 2013/0025971 describes a front-end carrier for a tractor that has a deck and a back wall fastened together at approximately a right angle. Two yokes are fastened on the back wall for attaching the carrier to a front-end loader of a tractor. The carrier can be lifted and tilted by the front-end loader hydraulic controls.

A number of loading devices are available commercially. These include so-called “carry-alls”, for example: the tractor carry-all sold by Reddick Equipment Co. (Williamston, N.C.), the HawkLine carry-all sold by Behlen Equipment (Columbus, Nebr.), and the King Kutter Carry All sold by Northern Tool+Equipment (Burnsville, Minn.), all of which have a pair of projecting forks; the PL-12 Carry-all sold by Leinbach Machinery (East Bend, N.C.) which has a horizontal frame for supporting loads; a tractor carry-all sold by Wheel Tractor (Kuiwen District Weifang City, Shandong Province, China) which has a horizontal platform and full-width front panel; the 3-pt. Hitch Hauler sold by Carry-On Trailer Corporation (Lavonia, Ga.), which has an open-walled box surrounding a closed floor; and the Universal Utility Carryall sold by Tractor Attachments Canada (Chilliwack, BC, Canada) which has a platform with post mounts for the addition of sides by an owner.

There remains a need for a utility platform that can be mounted on the front end of a tractor, skid steer loader, or other prime mover that has a high carrying capacity, can support and carry objects and materials of large dimensions, can be lifted to provide access to elevated positions, and can be easily configured by a user for a wide variety of applications.

### SUMMARY OF THE INVENTION

The present invention consists of a utility carrier for mounting on a prime mover having a hydraulically actuated hitch interface. The carrier includes an L-shaped frame having an upright back panel and a four-sided floor. Mounting linkages are secured on the back panel for releasably mounting the carrier on the hydraulically actuated hitch interface of the prime mover, which may be a tractor, skid steer loader, or the like. A pair of removable corner posts are provided and are releasably mounted adjacent the corners of the floor opposite the back panel. A pair of removable side panels are releasably mounted for pivotal movement on the sides of the floor between a laid-down position and an upright position engaging a corresponding one of the corner posts and the upright panel. A front panel is mounted to the corner posts and the side of the floor opposite the upright panel.

The L-shaped frame includes a plurality of upright beams arranged side-to-side and a corresponding plurality of longitudinal beams, one each of which extends at a right angle from and is secured to the bottom end portion of a corresponding one of the upright beams. A plurality of transverse beams are secured in a spaced relation to the upright beams.

The hydraulically actuated hitch interface may be any of the wide variety of hitch interfaces, for example a three-point hitch interface, a Euro-loader hitch interface, a skid steer loader interface, the so-called Deere interface, or a front-end loader interface.

In a preferred embodiment, a mounting plate is secured to the upright panel and serves as a mounting site for the mounting linkages.

In another preferred embodiment, the L-shaped frame consists of a plurality of upright steel box tubes arranged side-to-side and a corresponding plurality of longitudinal steel U-shaped channel members, one each of which extends at a right angle from and is secured to the bottom end portion of a corresponding one of the steel box tubes.

In a further preferred embodiment, a first end portion of the longitudinal steel U-shaped channel members has material removed along the edges to create a pair of opposing slots. A lower end portion of the upright steel box tubes is positioned inside the first end portion of the each of the channel members so that opposing end surfaces of the box tube are adjacent the opposing slots. Weldments are used to secure the channel members to corresponding ones of said box tubes at least along the slots.

While the carrier is intended primarily for attachment to a hydraulically actuated hitch interface at the front of a prime mover, it may also be attached to a hydraulically actuated hitch interface at the rear of a prime mover, such as to the common three-point hitch.

These and other objects of the present invention will be noted by those skilled in the art upon a review of this specification, the associated drawings and the appended claims.

### BRIEF DESCRIPTION OF THE DRAWINGS

FIG. 1 is a front perspective view of a utility carrier of the present invention mounted on a three-point hitch of a tractor.

FIG. 2 is a side perspective view of the utility carrier of FIG. 1 without front and side panels.

FIG. 3 is a front perspective view of a utility carrier of the present invention mounted on a front loader structure of a tractor.

FIG. 4 is a perspective view of the underside of a utility carrier of the present invention.

FIG. 5 is an enlarged perspective view of horizontal support channels used in the fabrication of a utility carrier of the present invention.

FIG. 6 is an enlarged rear perspective view of a utility carrier of the present invention showing the interconnection between vertical posts and horizontal supports.

FIG. 7 is a rear perspective view of a support plate mounted on a back panel of a utility carrier of the present invention.

FIG. 8 is a rear view of a utility carrier of the present invention showing mounting hardware secured to the support plate.

FIG. 9 is a rear perspective view of a utility carrier of the present invention showing the interconnection of the utility carrier with an industry standard three-point hitch.

FIG. 10 is an enlarged side view of a U-frame associated with a three-point hitch.

FIG. 11 is a rear perspective view of a utility carrier of the present invention showing an alternative three-point hitch apparatus.

FIG. 12 is a side perspective view of a utility carrier of the present invention showing an alternative coupler for mounting the carrier on a front-end loader apparatus.

FIG. 13 is a side perspective view of a utility carrier of the present invention showing a second alternative coupler for mounting the carrier on a front-end loader apparatus.

FIG. 14 is a front perspective view of a utility carrier of the present invention showing a corner post used to secure front and wall panels.

FIG. 15 is an enlarged upper perspective of a box-shaped support for a corner post.

FIG. 16 is an enlarged perspective view of the attachment of a side panel to the floor.

FIG. 17 is a side view of a truck on which a plurality of the utility carriers of the present invention are being shipped.

FIGS. 18 and 19 are side perspective views of a small farm utility vehicle being mounted on and carried on a utility carrier of the present invention.

FIG. 20 is a front perspective view of a carrier of the present invention showing the mounting of an electrically actuated winch and a box for holding a battery for operating the winch.

### DETAILED DESCRIPTION OF PREFERRED EMBODIMENTS

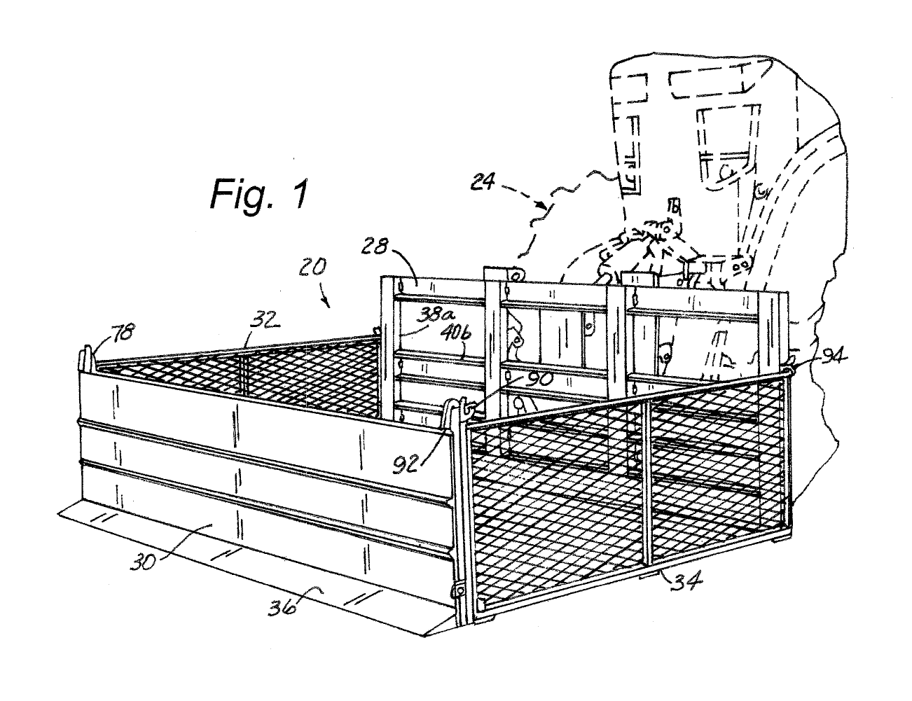

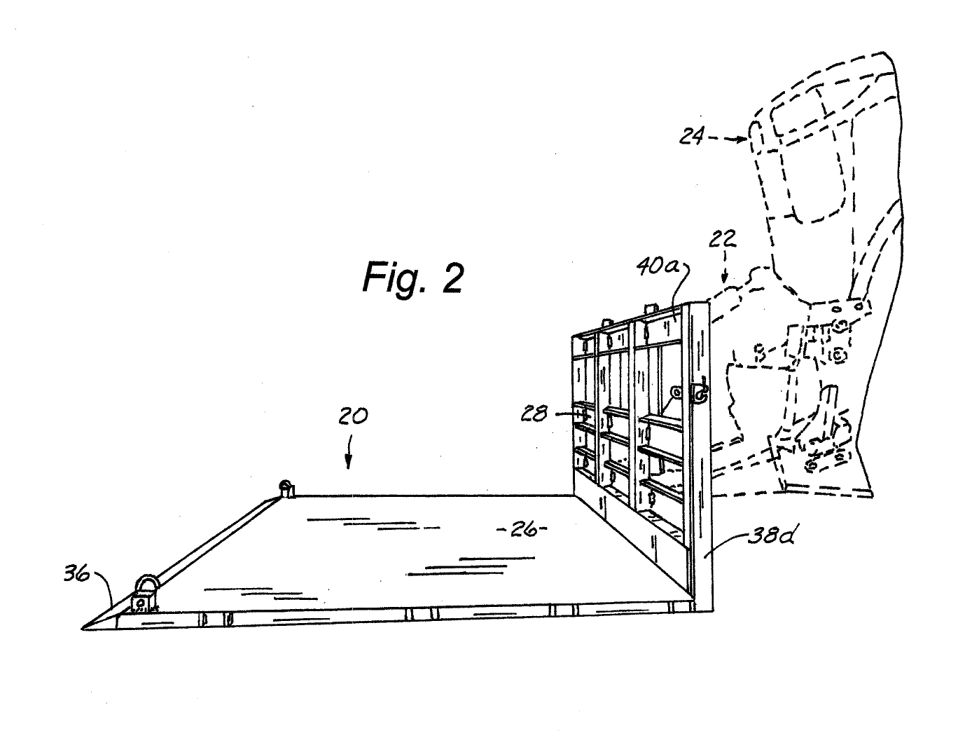

A front-end utility carrier for a prime mover of the present invention is illustrated in FIGS. 1 and 2, generally at 20, where it is shown attached to a three-point hitch 22 at the front end of a tractor 24. In its most basic conformation, the utility carrier 20 is generally L-shaped frame in cross-section, including a floor 26 and an upright back panel 28. The floor 26 is preferably a square or rectangle with straight sides to facilitate the addition of a front panel 30, a left side panel 32, and/or a right side panel 34. The leading edge 36 of the floor 26 preferably slopes downwardly to create a ramp that will assist in moving materials onto the carrier 20. Tread-patterned steel may be used in the fabrication of the deck surface of floor 26 and leading edge 36 to improve the traction of these surfaces.

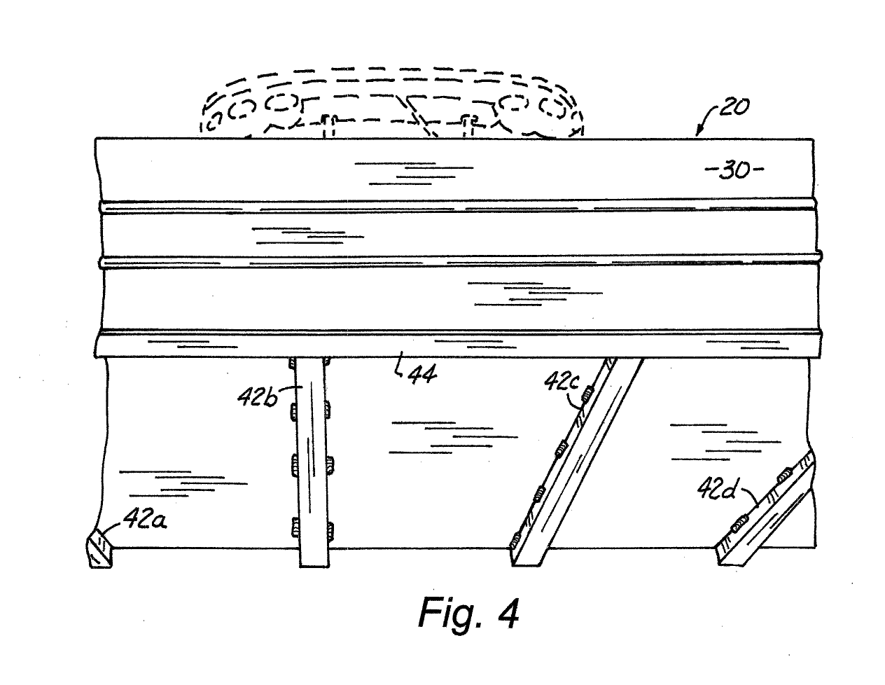

Back panel 28 includes four vertical posts 38a-d and three horizontal bars 40a-c (FIGS. 1-3) that are interconnected, for example by weldments, to form a rigid frame. In a preferred embodiment, the floor 26 is supported on four horizontal supports 42a-d (FIG. 4) that are each secured to a corresponding one of the vertical posts 38a-d and extend forwardly to where they are secured to a front perimeter frame member 44. The vertical posts 38a-d are preferably made of steel box tubes, while the horizontal bars 40a-c and the horizontal supports 42a-d are preferably made of open steel channels having a substantially U-shape in transverse cross section.

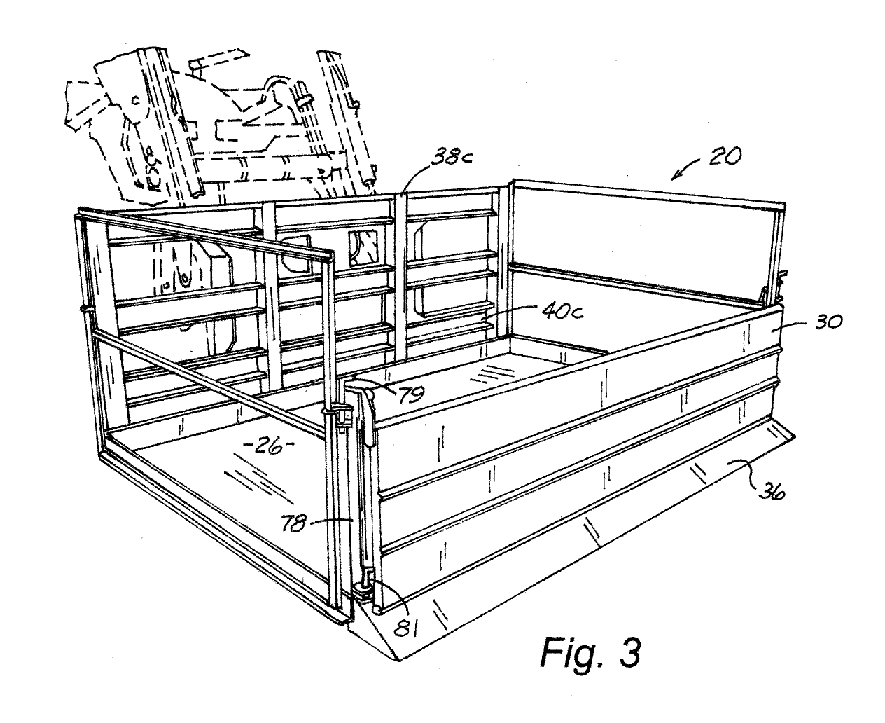

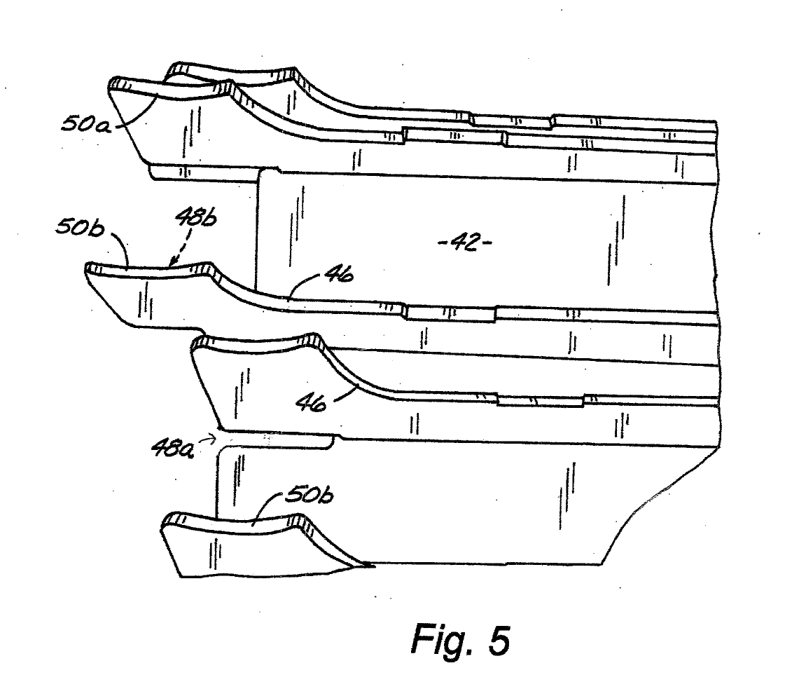

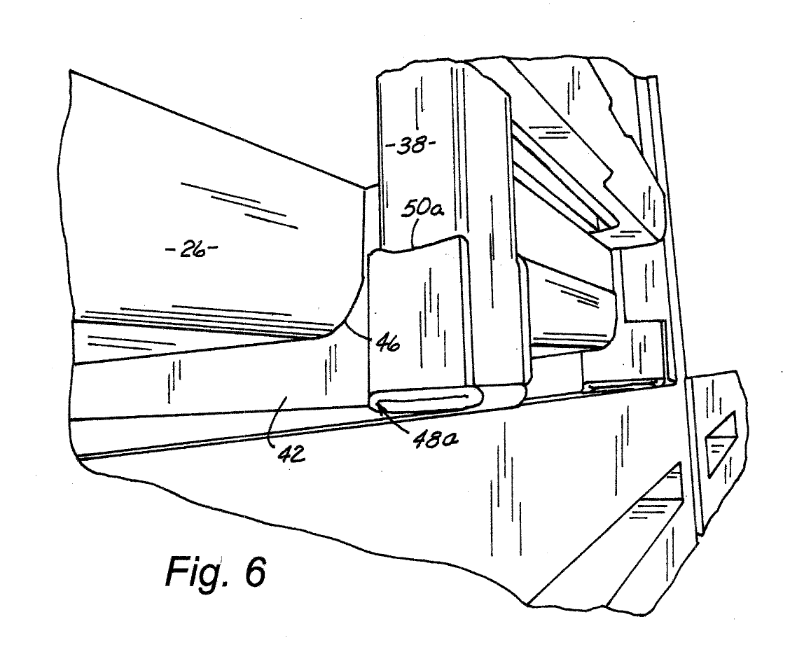

In the embodiment of FIGS. 1 and 2, the floor 26 and back panel 28 meet at a right angle and are secured to each other along their shared edge by weldments. In the embodiment of FIG. 3, the floor 26 curves upwardly in the vicinity of the back panel 28, transitioning from a horizontal to vertical orientation and is secured at least to the vertical posts 38a-d by weldments or the like. To accommodate the curved floor 26 as shown in FIG. 3, the horizontal supports 42a-d have curved side walls 46, as best shown in FIGS. 5 and 6, corresponding to the curvature of the floor 26 to provide support to the curved portion of the floor 26.

FIGS. 5 and 6 also show the configuration of the rearward ends of the horizontal supports 42a-d that assist in fabrication of the utility carrier 20 and strengthen the connection between the horizontal supports 42a-d to the corresponding ones of the vertical posts 38a-d. Specifically, material is removed from the lower corners creating slots 48a and 48b at the rearward end of each of the horizontal supports 42a-d. During fabrication, the vertical post 38 is inserted inside the rearward end portion of a corresponding one of the horizontal supports 42 and the parts are welded to each other along the edges of the horizontal support 42 adjacent the vertical post 38 (FIG. 6). A preferred feature is the creation of a concave curve 50a and 50b in the upwardly extended side wall portions of each of the horizontal supports 42a-d. These curves remove material from the horizontal supports 42a-d, thereby reducing the weight of the utility carrier 20, and also provide a stronger securement of the horizontal supports 42a-d to the vertical posts 38a-d when weldments are applied bridging the curves 50 and the side wall of the vertical posts 38a-d.

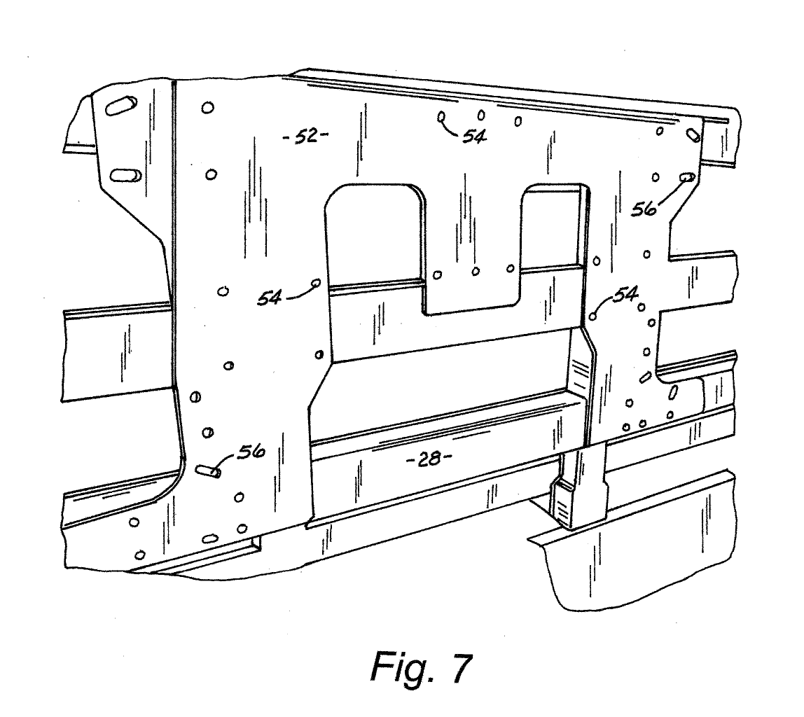

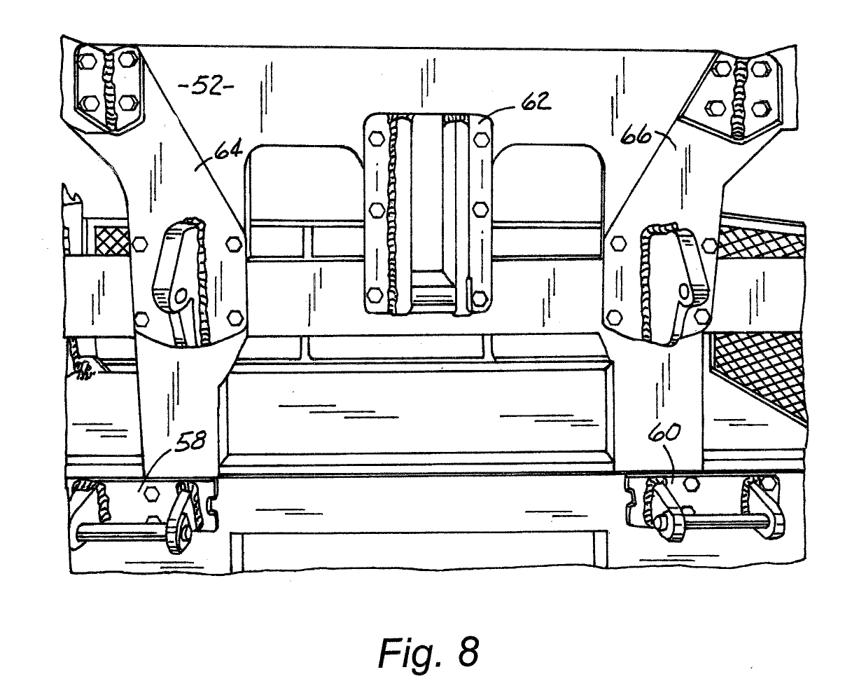

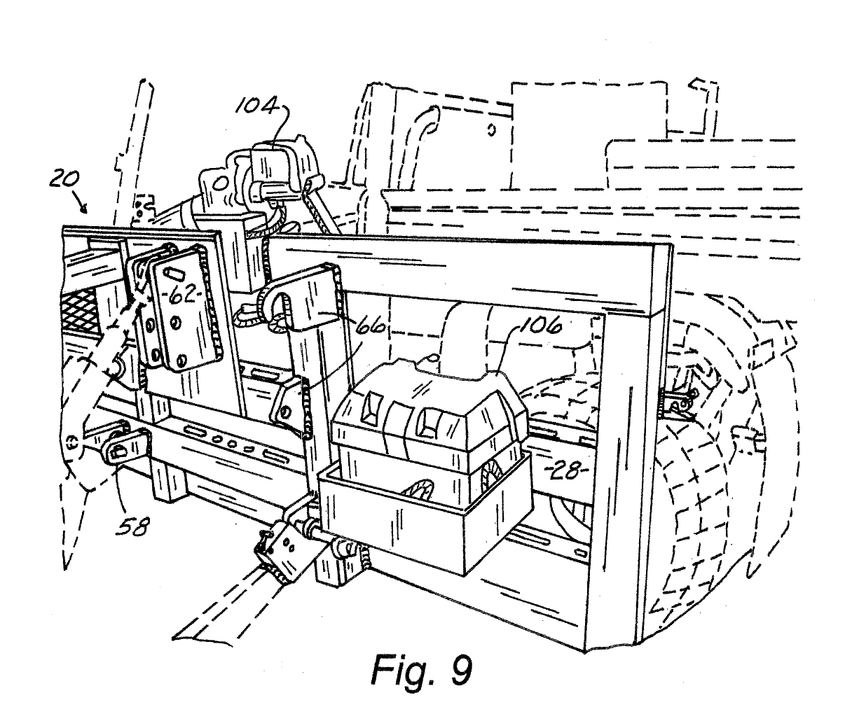

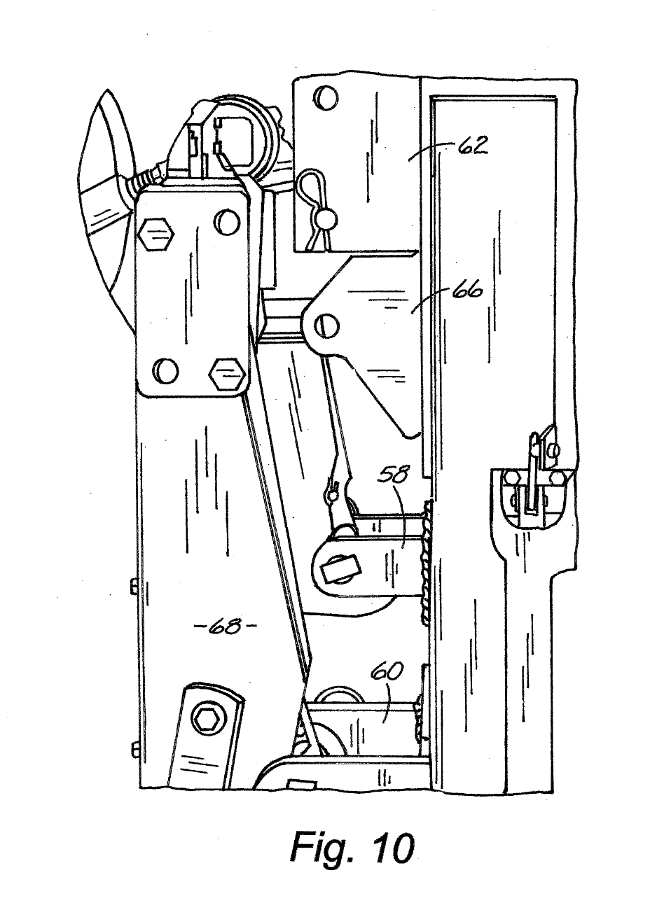

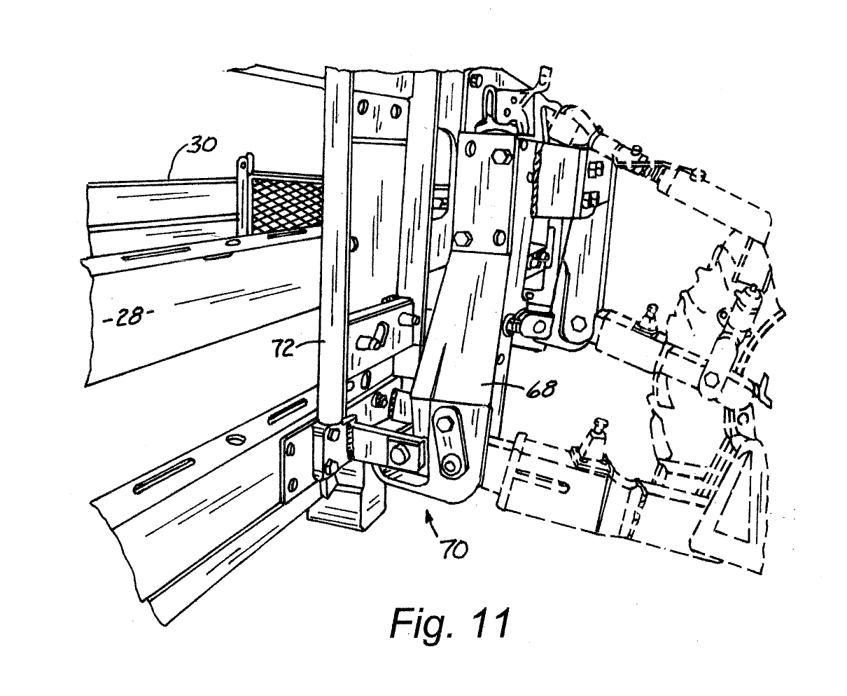

Flexibility in the attachment of the utility carrier 20 to a variety of prime movers and a variety of mounts or hitches, is provided in a preferred embodiment by a support plate 52 secured to the back side of the back panel 28 by weldments or the like (FIG. 7). A plurality of holes 54 and slots 56 are formed in the support plate 52 to provide means for attaching mounting hardware suitable for a variety of mounts and hitches. For example, as shown in FIG. 8, mounting hardware for a the industry standard three-point hitch are bolted to the support plate 52, consisting of a left side pin support 58 and right side pin support 60 for the hitch lifting arms and a center pin support 62 for the top link. Also shown bolted to the support plate 52 is mounting hardware for connection to a common front-end loader arrangement, including right side upper and lower attachment arms 64 and right side upper and lower attachment arms 66. In alternative embodiments, for example as shown in FIGS. 9 and 10, the mounting hardware 58-66 may be directly secured to the back panel 28. Note that in FIG. 10, an alternative three-point hitch mount is shown, including a U-frame 68. Another common alternative three-point hitch mount is shown generally at 70 in FIG. 11 wherein mounting plates 72 have been secured to the back panel 28.

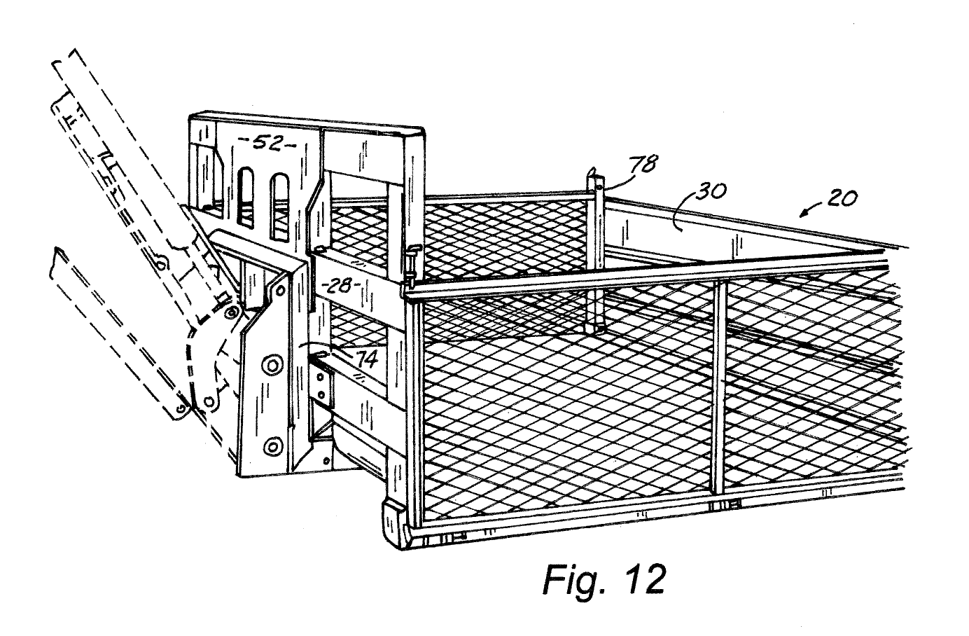

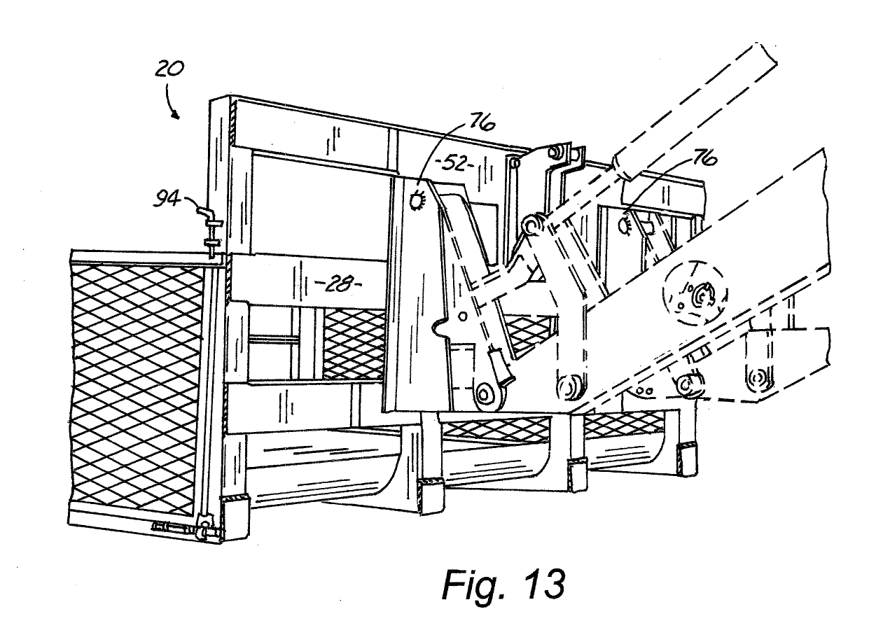

Alternative mounting systems for front-end loaders are shown in FIGS. 12 and 13. In FIG. 12, a skid steer-type coupler 74 is secured to the support plate 52 and is used to assist in coupling the utility carrier 20 to the front-end loader apparatus of a tractor (not shown). In FIG. 13, a pair of mounting brackets 76 are secured to the support plate 52 and are used to assist in coupling the utility carrier 20 to the front-end loader apparatus of a tractor (not shown).

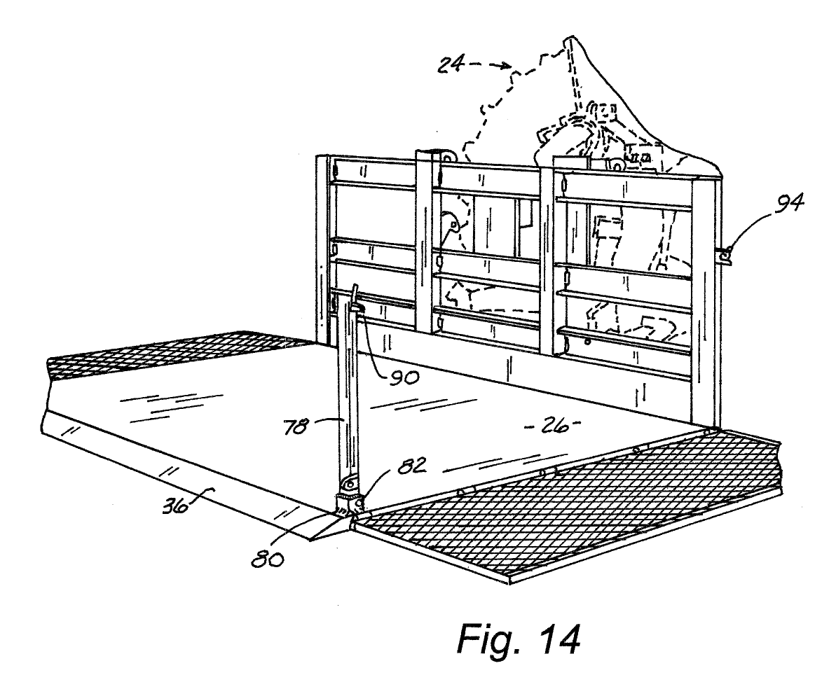

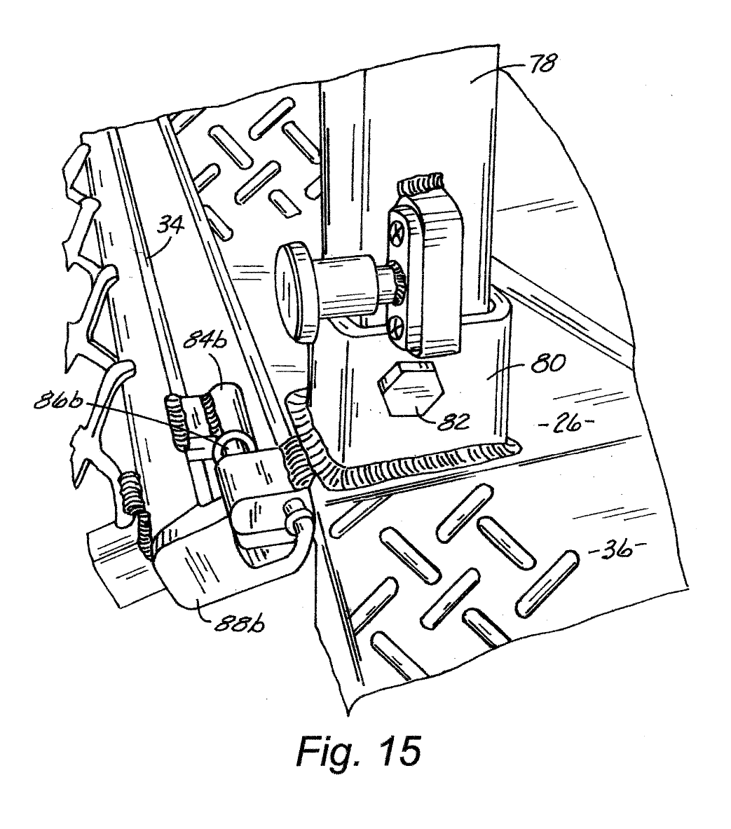

Corner posts 78 are used to support the front panel 30, the left side panel 32 and the right side panel 34 (FIG. 1). The corner posts 78 are inserted inside a box-shaped support 80 that is secured to the front corner of the floor 26. In a preferred embodiment, a bolt and nut combination 82 is used to secure the corner post 78 inside the support 80 (FIGS. 14 and 15).

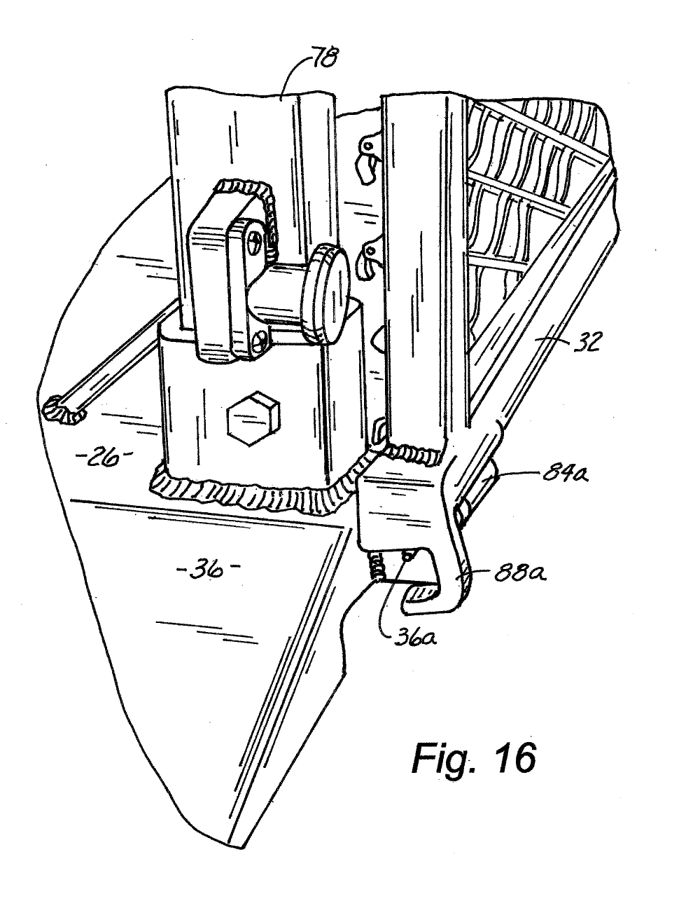

The side panels 32 and 34 are mounted on the utility carrier for pivotal movement between a lowered, substantially horizontal position (FIG. 15) and a raised, substantially vertical position (FIG. 16). Pivotal mounting is achieved through the use of a plurality of pins and barrels mounted on the utility carrier 20 and the panel 32, 34 and vice versa. In other words, the pins may be on the carrier 20 and the barrels may be on the panel 32, 34 or, alternatively, the pins may be on the panel 32, 34 and the barrels may be on the carrier 20. In the embodiment shown in FIGS. 15 and 16, three barrels 84a-c are mounted on the panel 32, 34 and three corresponding pins 86a-c are mounted on the carrier 20. It is preferred that the outer pins 86a-c be either of different lengths or mounted different distance from the corresponding barrels 84a-c so that not all of the pins 86a-c have to be initially aligned with their corresponding barrels 84a-c simultaneously. For example, center pin 86b might be mounted relatively closer to corresponding barrel 84b so that it will be first inserted into the 84b before the other pins 86a and 86c contact the corresponding barrels 84a and 84c. As the side panel 32, 34 is slidably moved to further insert pin 86b in barrel 84b, one of the outer pins, say pin 86c is placed to next come into contact with its corresponding barrel 84c and can readily be aligned for insertion. Upon further sliding movement, the remaining pin 86a will engage with and allow insertion into corresponding barrel 84a to complete the mounting of the panel 32, 34. In this way mounting of the panel 32, 34 is made much easier than requiring initial alignment or engagement of all three pins 86a-c and barrels 84a-c simultaneously.

The side panels 32, 34 have a novel system that prevents opening of the hinges except when the panel 32, 34 is close to vertical. A pair of C-shaped stops 88a and 88b are provided and one each is secured to a corresponding one of the bottom end corners of the panels 32, 34 just beyond the outside pins 86a and 86b. The stop 88 has an opening that is open toward the interior side of the panel 32, 34. When the panel 32, 34 is in a nearly vertical orientation, preferably between about 12 and 20 degrees from vertical, as illustrated in FIG. 16, the opening of the stop 88 is aligned with the pin 86a and so the panel 32 can be moved to the left or right along the axis of the pins to release it from the carrier 20. If the panel 32, 34 is not within the present angle of orientation, the opening in the stop will not align with the outside pins 86a and 86b (see FIG. 15) and the stop will prevent right or left movement of the panel 34 and so the panel 34 will be retained mounted on the carrier 20. The stops 88 thus prevent accidental dismounting of the panel 32, 34 unless it is within the present angle of orientation.

Referring back to FIGS. 1 and 14, the top of the corner post 78 includes a releasable latch 90 in which is received and releasably retained a latch bar 92 located at the top corners of the panel 32, 34. Accordingly, when the panel 32, 34 is raised to a vertical orientation, the latch bar 92 is captured in the releasable latch 90 and is thus secured to the corner post 78 and held in the vertical orientation. Because the releasable latch 90 is located outside the perimeter of the panel 32, 34, it prevents movement of the panel 32, 34 away from hinged attachment to the carrier 20 even though the stops 88 are aligned to permit such movement. The stops 88 act to prevent dislodgment of the panel 32, 34 unless it is within the preset angle of orientation without the use of any type of removable retainer or fastener, thus easting operation. The position that allows removal of the side panels 32, 34 is by nature unstable, so the latch 90 keeps the side panel upright, but is not needed to prevent dislodgement of the panel 32, 34 from the floor 26. The releasable latch 90 prevents the side panels 32, 34 from unwanted opening or folding from the upright to the laid-down position. A similar releasable latch 94 is mounted on the side of the back panel 28 to similarly retain the other side of the panel 32, 34.

The front panel 30 is releasably attached at each end to the tops and bottoms of the corner posts 78 by spring-loaded pins 79 and 81 (FIG. 3). The pins 79, 81 are spring-biased to hold the shaft of the pins 79, 81 in corresponding retainers of the corner posts 78 unless an operator raises the pins 79, 81 to release the front panel 30 from the corner posts 78.

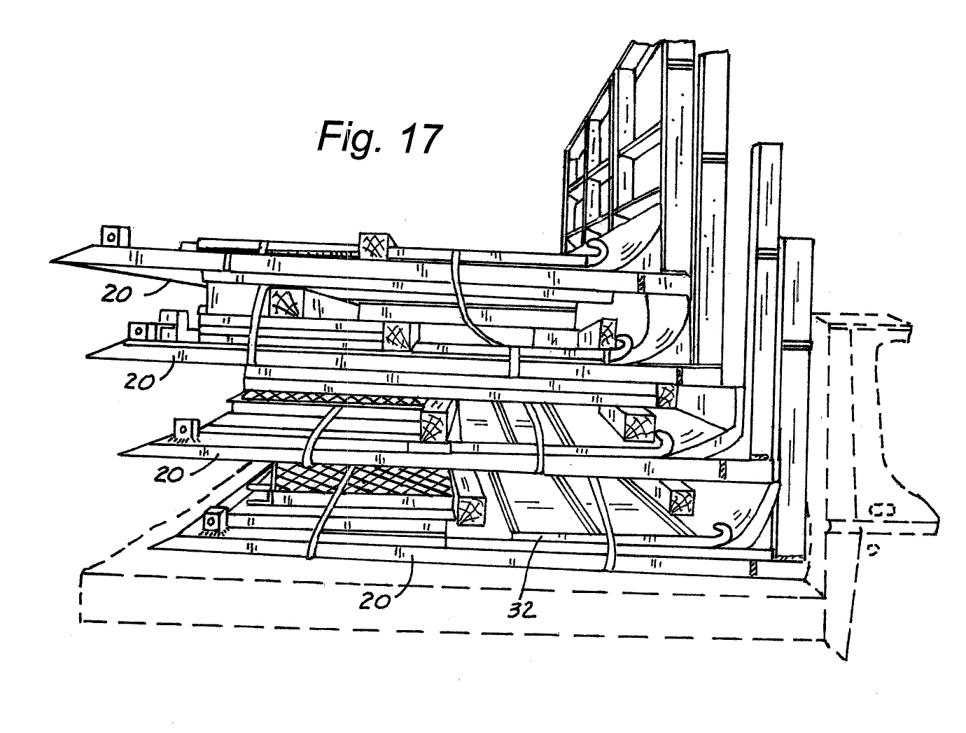

One of the important implications of the L-shape of the utility carrier 20 in its simplest conformation is that multiple carriers 20 can be stacked for efficient storage and shipping (FIG. 17). In addition, the panels 32 and 34, corner posts 78, and any other pieces or hardware needed by a purchaser to assemble the carrier 20 can be captured on the L-shaped carrier 20 so that each shipping unit is complete and individual units can be separated and delivered simply by lifting from the top of the stack. Preferably, the width of the carrier 20 would be within the carrying confines of trucks used to transport the carriers 20 for sale.

Utility carriers of the present invention have a wide variety of uses. One use is to assist in balancing the weight distribution of a tractor or other prime mover to which the carrier is attached. For example, when a tractor, particularly a wheeled tractor, is drawing an implement a considerable down force is frequently transferred to the rear of the tractor. If the down force is excessive, it can cause the front wheels of the tractor to become unweighted and may adversely affect steering of the tractor. By using a carrier of the present invention, possibly with added weight, additional down force can be applied to the front wheels of the tractor. In a preferred embodiment, the carrier 20 is engineered to have a safe carrying capacity of about 3,000 pounds, an amount that is commonly used to counterweight a 200 HP tractor.

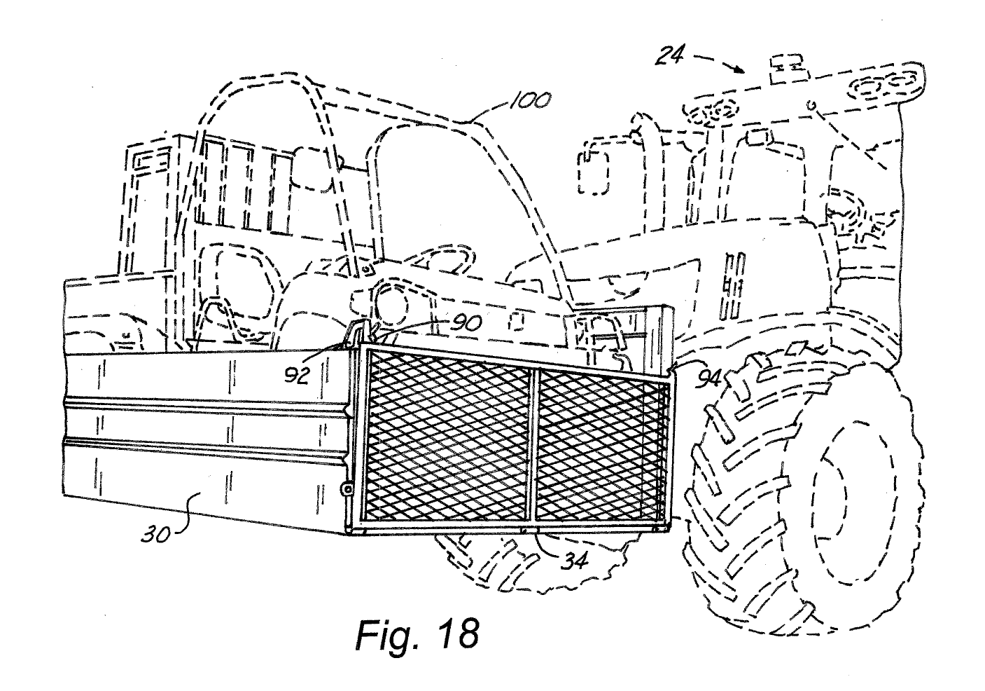

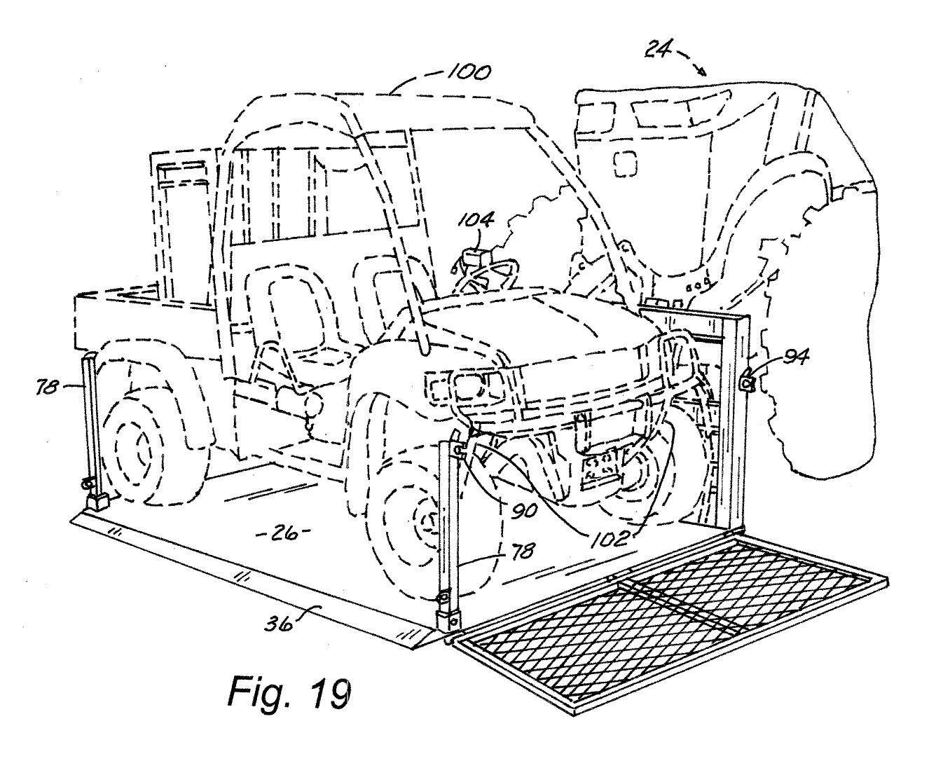

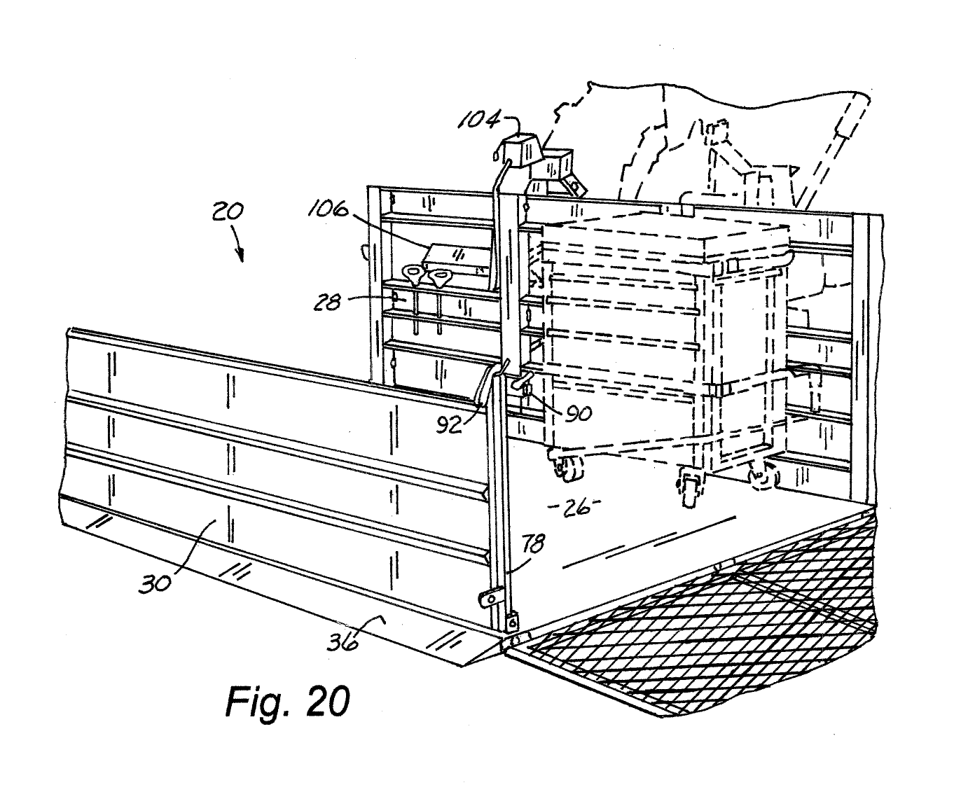

Another use of the utility carriers of the present invention is in the transport of tools and the like often needed by an operator of a tractor or other prime mover to which the carrier is attached in the course of work where they will always be in ready access. For example, hand tools for effecting repairs can be carried on the utility carrier, powered tools such as impact wrenches and an associated air compressor can be transported on the carrier, a vice can be mounted on the carrier, for example on the back panel at a desired working height, an electric winch 104 and a battery box 106 for holding a battery may be mounted on the back panel 28 (FIG. 20) so that the winch 104 can be used for dislodging objects, such as tree trunks, and moving objects onto the carrier. One particularly important application of the carriers of the present invention is the ability to load, carry, transport and unload small farm utility vehicles, such as the Gator™ vehicle sold by John Deere or the Brutus™ vehicle sold by Polaris. Farmers are often operating alone and require transportation to and from a remote field location where a tractor is being used. By using the utility carriers of the present invention, a farmer can transport a farm utility vehicle to the remote location and use it as a much quicker and efficient form of transportation to and from the remote location than having to use the tractor itself. The value is particularly noticed if there is a mechanical problem with the tractor such that it cannot be used for on-the-road transportation. FIGS. 18 and 19 show a farm utility vehicle 100 mounted on a utility carrier 20 for transport by the tractor. Note the use of tie-downs 102 to secure the farm utility vehicle 100 to the carrier 20 and that the carrier 20 is preferably of a size to wholly contain within its perimeter the vehicle 20 such that the front and side panels 30, 32, 34 can be used as well.

Another advantage of the utility carriers of the present invention is the ability to raise the carrier 20 to an elevated position. Objects and materials can be raised in this way, for example for storage on an elevated shelf or platform. Of course the carrier 20 could likewise be used to move such stored objects or materials from the elevated position to the ground. The carrier 20 may also be raised to an elevated position to provide an elevated working platform for users, for example to trim trees, repair elevated portions of building, and the like. Preferably the front panel 30 and both side panels 32, 34 would be mounted and secured to provide a work platform that meets OSHA requirements (FIG. 3).

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

I claim:

1. A utility carrier for mounting on a prime mover having a hydraulically actuated hitch interface, comprising:
(a) an L-shaped frame including an upright panel and a four-sided floor;
(b) mounting linkages secured to the upright panel for releasably mounting the L-shaped frame on the hydraulically actuated hitch interface of the prime mover;
(c) a pair of removable corner posts for releasable mounting adjacent the corners of the floor opposite the upright panel;
(d) a pair of removable side panels for releasable mounting for pivotal movement on the sides of the floor between a laid-down position and an upright position engaging a corresponding one of the corner posts and the upright panel; and
(e) a front panel mounted to the corner posts and the side of the floor opposite the upright panel.

2. A utility carrier of claim 1, wherein said L-shaped frame comprises a plurality of upright beams arranged side-to-side and a corresponding plurality of longitudinal beams, one each of which extends at a right angle from and is secured to the bottom end portion of a corresponding one of said upright beams.

3. A utility carrier of claim 2, wherein said upright panel comprises a plurality of transverse beams secured in a spaced relation to said upright beams.

4. A utility carrier of claim 2, wherein said floor comprises a deck surface mounted on said longitudinal beams.

5. A utility carrier of claim 1, wherein said hydraulically actuated hitch interface is selected from the group consisting of a three-point hitch interface, a Euro-loader hitch interface, a skid steer loader interface, and a front-end loader interface.

6. A utility carrier of claim 1, further comprising a mounting plate secured to the upright panel and to which are secured said mounting linkages.

7. A utility carrier of claim 1, wherein said L-shaped frame comprises a plurality of upright steel box tubes arranged side-to-side and a corresponding plurality of longitudinal steel U-shaped channel members, one each of which extends at a right angle from and is secured to the bottom end portion of a corresponding one of said steel box tubes.

8. A utility carrier of claim 7, wherein:
(a) a first end portion of said longitudinal steel U-shaped channel members with material removed along the edges to create a pair of opposing slots;
(b) a lower end portion of the upright steel box tubes positioned inside the first end portion of the each of the channel members so that opposing end surfaces of the box tube are adjacent the opposing slots; and
(c) weldments securing at least said channel members to corresponding ones of said box tubes along the slots.

9. A stop mechanism for a pivoting panel, comprising:
(a) a support having an extended edge;
(b) a panel having an extended edge;
(c) a hinge releasably mounting the extended edge of the panel to the extended edge of the support for pivotal movement of the panel relative to the support sequentially through a first, second and third range of pivotal orientations, wherein said hinge releases the panel upon sliding movement of the panel in a first direction along the extended edge;
(d) a stop positioned adjacent the hinge to obstruct sliding movement of the panel in said first direction within said first range and said third range of pivotal orientations of the panel; and
(e) an opening in the stop that permits sliding movement of the panel in said first direction within said second range of pivotal orientations of the panel.

10. A readily attachable pivoting panel, comprising:
(a) a support having an extended edge;
(b) a panel having an extended edge;
(c) a plurality of hinges, each comprising a pin and a corresponding barrel, releasably mounting the extended edge of the panel to the extended edge of the support for pivotal movement of the panel relative to the support, wherein said hinges release the panel upon sliding movement of the panel in a first direction along the extended edge;
(d) positioning the pins and corresponding barrels on the extended edges of the support and the panel such that upon mounting of the panel to the support and sliding movement of the panel in a second direction opposite to the first direction along the extended edge, a first one of the pins engages its corresponding first barrel prior to engagement by of a second pin with its corresponding second barrel and upon further sliding movement of the panel in the second direction the second pin engages the second barrel.
